(19) United States
(12) Patent Application Publication
(10) Pub. No.: US 2013/0138543 A1
(43) Pub. Date: May 30, 2013

(54) SYSTEMS AND METHODS FOR MANAGINIG CHARITABLE CONTRIBUTIONS AND COMMUNITY REVITALIZATION

(71) Applicant: Mark G. Dreyer, Aurora, IL (US)

(72) Inventors: MICHELLA G. McMASTER, (US); Mark G. Dreyer, Aurora, IL (US)

(21) Appl. No.: 13/747,272

(22) Filed: Jan. 22, 2013

Related U.S. Application Data
(63) Continuation of application No. 12/642,256, filed on Dec. 18, 2009, now abandoned.
(60) Provisional application No. 61/203,552, filed on Dec. 22, 2008.

(51) Int. Cl. G06Q 30/02

(52) U.S. Cl. CPC G06Q 30/0279
USPC 705/35

(57) ABSTRACT

A system and method for managing charitable contributions and community revitalization includes efficiently providing donations to charities, matching donors with recipients, identifying entities and organizations that may be able to help a community meet the development goals thereof, and facilitating communications between information providers and individuals seeking information. The system and method also include developing a social network of individuals and organizations who are interested in the charitable contributions and community revitalization, and providing information regarding donations made by members of the social network and other contributors.

### CROSS REFERENCE TO RELATED APPLICATIONS

The present application is a continuation of U.S. patent application Ser. No. 12/642,256 filed on Dec. 18, 2009, which in turn claims benefit of U.S. Provisional Application No. 61/203,552, filed Dec. 22, 2008, both of which are hereby incorporated by reference herein in their entirety.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention is directed to systems and methods for managing charitable contributions and community revitalization.

2. Description of the Background of the Invention

Historically, billions of dollars have been appropriated at a federal level, state level and donated by all types of entities to address the hungry, the homeless, the illiterate, euthanizing of pets, and care of people such as seniors living in isolation, yet the problems persist. Typically, a lack of accessibility and/or a lack of awareness of benefits lead to appropriated and/or available funds and resources to go unused. The accessibility of retail sales (for example, at a physical store, a kiosk, or an electronic store accessed using a computer or mobile device using the Internet or a cellular telephone network) may help alleviate these chronic issues.

Charities expend substantial monies and resources in an attempt to find volunteers, secure donations and make their services available to those in need. Individuals and organizations may expend substantial resources and time trying to determine to whom to donate, how to donate, or how to find help with donations. Additionally, individuals and organizations generate waste and byproducts that charities could use (for example, excess paint, pens, paper, markers, organizer, towels, and the like). Charities typically have unfunded needs for such items which go unmet. In addition, a charity may not have sufficient marketing resources and therefore may have a marketing campaign that is inconsistent and/or directed at the wrong audience. For example, a message to inform a potential client of the charity about accessing the charities services may be designed, because of the lack of market resources, identically to messages that appeal to the contributor or the employee of the charity. Such a message may carry little meaning for the target audience and may not generate interest from potential clients. For example, the message may not clearly identify specific services provided by the charity and whom to contact to obtain such services. Similarly, a message that is directed to potential contributors to a charity may not clearly identify the unfunded needs of the charity.

In small charities and mid-market and below for-profit organizations, development functions are typically fragmented across multiple positions. Additionally, the background and experience of the staff at such charities, typically, does not lend itself to raising funds or distributing funds in a strategic manner. The skill level of the staff at such nonprofit organizations may generally be in direct services and programming.

With respect to companies, such as a for-profit company or corporation, who may provide contributions to charities skills of a staff member at such a company are generally in accordance with the functional position held thereby and not philanthropy. Further, at small to mid market for-profit companies, development functions are often distributed among staff members who have other (typically, non-philanthropic) responsibilities. Usually the executives charged with approving donations or responding to requests for donations and/or sponsorships are not well versed in a strategic approach to giving, the corresponding tax advantages of such giving that may be available, the waste or byproducts that the company generates, and how it might be useful for donation. Such staff member's time is already stretched, which may lead to lack of response or inappropriate response to requests. Often, once a for-profit company decides to sponsor or donate or launch a cause related marketing campaign, the rank and file employee members are not made aware of or included in developing the campaign, leading to less than optimum results in execution. For example, a for-profit company may spend substantial funds in a manner that results in minimal donations to a charity. In other instances, a company may spend money to dispose of a product that could, otherwise, be used by a charity. Further, if such a company and charity were made aware of each other, the company could eliminate the disposal cost while creating a donation and substantial goodwill and the charity would be better able to serve its clients.

All charities have the same needs: people, money and resources and many times such needs go unmet. All corporations have the same needs: customers, tax savings, marketing effectiveness and often their positions are not optimized.

Corporate Social Responsibility and The Fourth Sector, which are for benefit corporations, are gaining ground. Most if not all leaders are aware that they need to be positioning their companies and organizations to be concerned about the triple bottom line (i.e., environmental sustainability, social responsibility, and financial performance) but they lack the time, resources and know how to do it. Further, the monies being allocated to today's traditional marketing venues—newspaper, radio, TV, direct mail, emails, websites are more about sales than values and tying the corporate approach strategically to causes of great importance will benefit the world.

Individuals often find themselves facing major life changes and the amount of information and resources available to such individuals make it difficult to obtain such information and resources using a single telephone call. For example, an individual may need to do extensive telephone or Internet research to obtain assistance with a question or problem, to find cohesive help to move the life of the individual forward, or to enable the individual to deal with substantial changes in daily demands and/or lifestyle. Examples are job transition, senior/dependent care, and money changes. The problems faced by an individual are not limited to chronic issues. Such problems may be positive in nature—possibly the individual wants to improve their image or maybe needs some help with etiquette. The growth desired may be found in nature as well, such as becoming a better singer, dancer or golfer. The individual has an area he or she wants to change or needs help with and assistance in addressing such concerns is not available from a single source (e.g., a telephone call).

Additionally, people fortunate enough to be in transition from homelessness to housing may find themselves trying to deal with daily problems of life and, due to their inability or lack of available resources where they are located, may be unable to solve such problems and may not successfully make the transition.

Further, in cases of extreme disasters like the floods of 2008 in Iowa and Illinois or hurricane Katrina of 2005 in New Orleans, there is not a cohesive coordinated approach to assisting those individuals in need at the moment of such crises. Again, those impacted by these disasters are overloaded and burdened with whom to call, the number of people who must be contacted, and the volume of calls that must be made to obtain information or resources.

Entrepreneurship is on the rise in both for-profit and nonprofit organization, however such entrepreneurship efforts are sometimes fragmented. Entrepreneurs lack resources to market themselves and their skills effectively. Further, entrepreneurs of services face the same barriers as other organizations including affordability of location, cost of supplies and cost of marketing their offerings. Traditionally, cooperatives, chambers of commerce and other like structures have been formed to help promote business and services for these individuals.

Communities often expend substantial resources yet lack skills in economic development to attract organizations to their area. The approaches to doing so are fragmented and lacking in a set of industry standards. Additionally, organizations expend substantial resources attempting to find the right community and location. While some of the data needed is available electronically, a majority is not, and with the advent of the computer, these functions could be consolidated into one database matching engine and marketing engine for the organizations and the communities to use. Further, often after the completion of a comprehensive plan or Tax Increment Financing Plan, communities lack the ability to execute the plan and achieve the goals set thereby. In addition, throughout the world, there are areas and communities that stay in a constant state of blight. By growing entrepreneurship from a local level, addressing the issues and franchising these hard to turn areas may be rejuvenated.

Today, there is not a dominant social network focused on good news. The majority of news is negative. A social network is designed to become the premier network for good news stories and deeds may supply such deficiency.

For-profits, for benefits, nongovernmental, nonprofit, individuals, entrepreneurs, communities and organizations are all seeking ways to grow organically and provide at the local level. A comprehensive approach may be used to foster growth using the resources available from such organizations and/or individuals.

### SUMMARY OF THE INVENTION

According to one aspect of the present invention, a computer program product for processing a donation from a donor to a recipient is embodied on a computer-readable medium and includes code that, when executed, causes the computer to receive data associated with a transaction undertaken by the donor, identify a charity to receive a donation in accordance with the data, and determine an escrow amount associated with the charity. The computer program product further causes the computer to calculate a donation amount in accordance with the data and the escrow amount and transfer a donation equal to the donation amount to the recipient.

According to yet another aspect of the present invention, a method of operating an electronic display includes the steps of receiving information regarding a donation, associating a region of the electronic display with the donation, wherein the area occupied by the region is associated with the value of the donation, and generating an image associated with the region to be displayed, wherein the image includes at least a portion of the information.

In accordance with a still further aspect of the present invention, a computer program product for managing an exchange of a service or donation between a first entity or individual and a second entity or individual, the computer program product embodied on a compute-readable medium and including code that, when executed, causes the computer to operate a database that tracks first points and second points associated with the first entity or individual and the second entity or individual, respectively. The computer program product causes the computer to also track information regarding a service or donation provided by the first entity or individual to the second entity or individual, develop a value in points for the service or donation provided by the first entity or individual, generate a first new value of the first points that is a result of adding to the value of the first points associated with the first entity or individual an amount equal to the developed value, generate a second new value of the second points that is a result of deducting from the value of second points associated with the second entity or individual an amount equal to the developed value, and store the first new value and the second new value in the database.

### BRIEF DESCRIPTION OF THE DRAWINGS

FIG. 1 shows a donation processing system in accordance with the present invention;

FIG. 2 illustrates a flowchart of the donation processor of the donation processing system shown in FIG. 1;

FIG. 3 depicts a flowchart of how donation are processed by the donation processing system shown in FIG. 1;

FIG. 4 depicts a flowchart that shows how donations that have been escrowed may be released by the donation processing system shown in FIG. 1;

FIG. 5 shows a flowchart of a process of updating data collected by the donation processing system shown in FIG. 1;

FIG. 6 depicts a flowchart of illustrating generation of a dashboard for a social network;

FIG. 6A shows an example of the dashboard generated by the flowchart of FIG. 6;

FIG. 7 shows a system for organizing a program in accordance with the present invention;

FIG. 7A shows a web page that provides information regarding a program organized using the system shown in FIG. 7;

FIG. 8 shows a flowchart of a process for developing a donation program for a company;

FIG. 9 shows a system that develops a plan to help revitalize a community in accordance with the present invention;

FIG. 9A shows a web page used to enter information into system shown in FIG. 9;

FIG. 10 depicts a flowchart of a matching engine process used by the system shown in FIG. 9;

FIG. 10A illustrates a page of a web based report generated by the matching engine depicted in FIG. 10;

FIG. 10B depicts another page of the web based report generated by the matching engine depicted in FIG. 10;

FIG. 11 shows a flowchart of how a consumer may design a customized product;

FIG. 12 shows a flowchart of a system for allowing an individual to obtain information from another individual;

FIG. 13 shows an information display system that displays information regarding donations;

FIG. 14 shows a system for electronic providing information regarding discounts to a consumer and the fulfillment thereof;

FIG. 15 illustrates a system that matches philanthropists with organizations and/or individual who may benefit from contributions made thereby;

FIG. 16A shows a flowchart of a system for redeeming points accrued by an individual; and

FIG. 16B shows a flowchart of a system to notify an individual when a recipient makes use of points or services provided by the individual.

Other aspects and advantages of the present application will become apparent upon consideration of the following detailed description and the attached drawings, in which like elements are assigned like reference numerals.

### DETAILED DESCRIPTION OF THE PREFERRED EMBODIMENTS

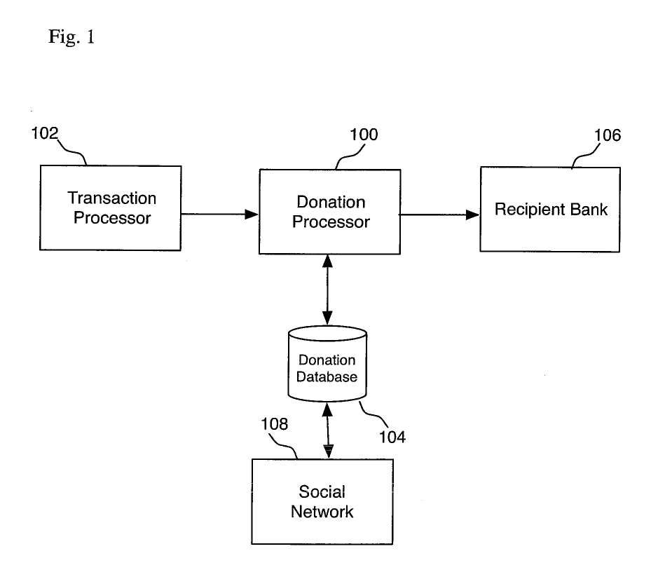

FIG. 1 shows a donation processor 100 that receives transaction data from an transaction server 102. The transaction server 102 may be an e-commerce server that manages purchases made at an online store or a system used to track purchases made at a retail store or an online store (e.g., a store accessible using the Internet or a cellular telephone network). The store may sell either services or products and may be associated with a number of charitable organizations. A portion of the proceeds from each product or service sold by the store may be donated in substantially real-time to one or more charitable organizations selected by the purchaser of the product or service. In addition, the store may sell products, for example, piggy banks that not only generate a donation when such product is purchased, but the product provides a place for the owner (either the purchaser or a person who has received the product as gift) of the product to collect money (e.g., extra change). The owner may return to the store with the product and the contents thereof may be donated to a charity selected by the owner. In exchange, the owner may receive a coupon or a credit to make additional purchases at the store, wherein the additional purchases generate additional donations to a charity selected by the owner.

The transaction data sent by the transaction server 102 comprises information that identifies a product purchased by a consumer, a price paid for the product, and the consumer who purchased the product. The transaction information may also include information regarding a charity selected by the consumer to which a donation should be made. In some cases, the transaction information includes demographic information provided by the consumer. In some embodiments, transaction processor 102 may send transaction data to the donation processor 100 in response a return of a product by consumer either for a refund or an exchange of another product. In such cases, the transaction data includes information that identifies the consumer, the product, and whether the consumer received a refund or another product in exchange.

In some embodiments, a consumer (or donor) may make a donation without having to make a purchase. For example, the donor may use a kiosk at a retail store to make a donation and the kiosk generates transaction data for the donation and transmits such information to the donation processor 100. In another example, the donor may make visit a web site using the Internet or the cellular network to make the donation. The web server generates and sends the transaction data to the donation processor 100. In still another example, the donor may call a predefined telephone number to make a donation and either a human or automated operator may obtain specifics about the donation (such an amount and a recipient). A system used by the operator (either human or automated) may generate and send the transaction data to the donation processor 100.

In some embodiments, the transaction data may include information about from where the donor/consumer made the donation. Such information may be gathered by querying the donor/consumer or by using electronic location methods such as GPS data from a mobile device. In other embodiments, the donor/consumer may request that the donation be used in a particular community (for example, a donation to the American Red Cross may include a request that such donation be used in New Orleans). Such location information may be included in the transaction data and be forwarded by the donation processor to the organization that receives the donation.

The donation processor 100 records the transaction data sent by the transaction processor 102 into a donation database 104. If transaction data is related to a purchase made by the consumer, the donation processor 100 determines the charity to which a donation is to be made and the amount of the donation. In addition the donation processor 100 determines if the donation should be sent to the charity or withheld. The donation may be withheld until the total of the values of donations allocated for the charity exceed a predetermined escrow amount. The donation processor 100 sends the donation to a payment system 106 that accepts payments made to the charity. The payment system may accept payments including PayPal transfer, via a web service, direct deposit, a wire or bank transfer. In some embodiments, the donation processor 100 may generate a check that is mailed to the charity. In this manner, the donation processor 100 is able to provide near real-time donations to the charity once the escrow amount associated with the charity is met.

The donation database 104 may be used to provide information to social network server 108. The members of the social network may be people and/or organizations who have made purchases that have resulted in a donation processed by the donation processor 100 or, as is described below, people and/or organizations that have volunteered to provide assistance to others.

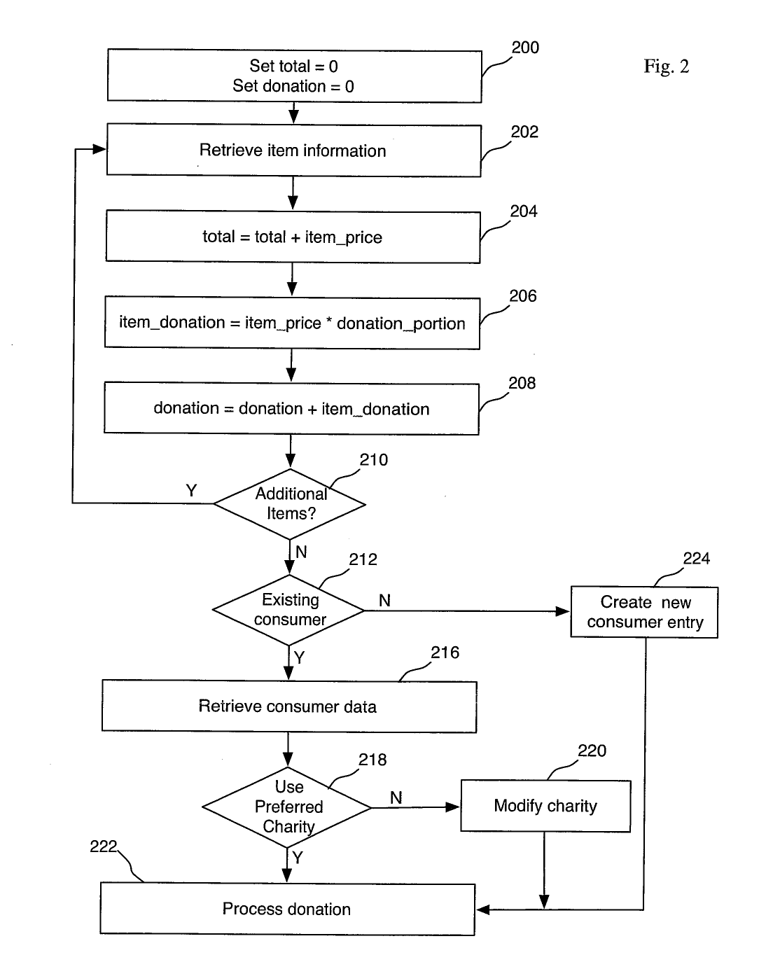

FIG. 2 illustrates a flowchart of one embodiment of how a donation processor 100 operates in response to transaction data. A block 200 sets the values of variables total and donation to zero. A block 202 determines from the transaction data an item that a consumer has purchased. The block 202 queries the database 104 to retrieve information regarding the item including the price of the item and a portion (denoted by the variable donation_portion) of the price of the item that is to be donated to charity. In some embodiments the portion of the price donated to charity depends on the profit generated by the sale of the item. In other embodiments, the portion of the price donated is associated with revenue generated by the sale of the item. In still other embodiments, the amount of the donation is fixed and does not depend the price of the item. The amount of the donation associated with the items sold in a store may vary from item to item.

A block 206 determines the value of a variable item_donation that represents amount of the donation associated with the purchased item. For example, the block 206 multiplies the price of the item (item_price) with the portion of the price that is to be donated (donation_portion) to calculate the value of the variable item_donation. A block 208 increments the value of the variable donation by the value of the variable item_donation.

In some embodiments, separate transaction data are sent for each item that is purchased by the consumer. In other embodiments, transaction data may be associated with the sale of one or more item to a consumer. A block 210 determines if there are additional items purchased by the consumer that have not been processed. If there are, execution proceeds to the block 202. The blocks 202 through 210 are executed in this manner until all of the items represented by the transaction data are processed.

After the block 210 determines that there are no other items remaining to be processed, control passes to a block 212 that cheeks if the purchase represented by the transaction data was made by an existing consumer. If so, control passes to a block 216, otherwise, control passes to a block 224.

The block 216 retrieves data regarding the consumer from the database 104. The data regarding the consumer may include identification information such as a name and address, billing and/or credit card information, and information regarding a preferred charity to which the consumer wishes to have donations made. In some embodiments, the consumer may be able to modify the preferred charity at the time of purchase and such information is sent as part of the transaction data. In such embodiments, a block 218 determines whether the consumer wishes to modify the preferred charity and, if so, control passes to a block 220, otherwise control passes to a block 222. The block 220 modifies the database 104 to record the new charity associated with the consumer. The block 222 processes the donation in a manner described in detail hereinbelow.

Returning to block 212, if the transaction data are in response to the purchase of the item by a new consumer, the block 224 creates an entry in the database 104 for the new consumer. In such cases, the transaction data include information regarding the identity of the consumer, payment method used by the consumer, and the charity to which the consumer prefers to have contributions made. After the entry regarding the new consumer is made, control passes to the block 222.

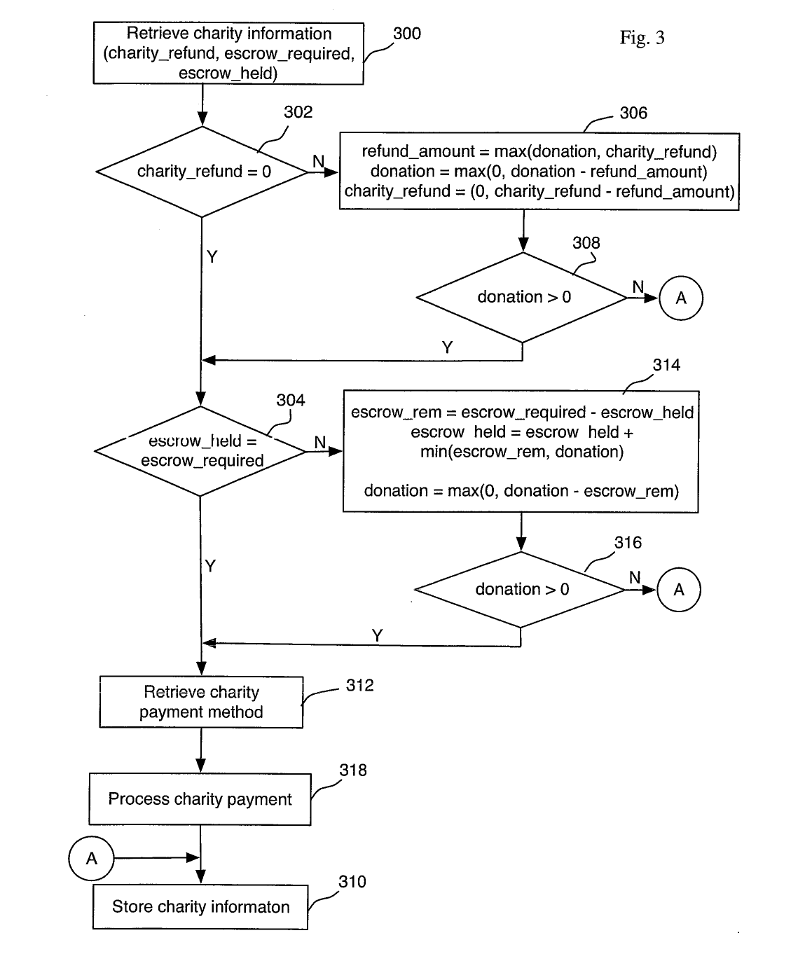

FIG. 3 shows a flowchart that illustrates the processing of a donation, for example, by the block 222, in one embodiment of the donation processor 100. In particular, a block 300 retrieves charity information from the database 104 including values of any refunds of donation previously provided to the charity (charity_refund), any escrow that is required to be withheld before donations are sent to the charity (escrow_required), and the amount of the escrow that has been accumulated by previous purchases designating the charity (escrow_held). In some embodiments, the value of the amount of the escrow that is required is identical for all charities. In other embodiments, the value of the amount of the escrow that is required is associated with a particular charity and depends on the number of consumers who have selected the charity as their preferred charity. In still other embodiments, the value of amount of escrow that is required is predetermined based on negotiations with the charity. Other ways to determine the value of the amount of escrow required may be used.

A block 302 checks the value of the variable charity_refund. The value of the variable charity_refund indicates donations have been previously been made to the charity in response to the purchase of an item and where the item has been subsequently returned to the store. If the value of the variable charity_refund is zero, control proceeds to a block 304, otherwise, control proceeds to a block 306. The block 306 calculates a value of a variable refund_amount that is the maximum of the value of the donation and the value of the variable charity_refund. The value of the variable refund_amount represents the amount of the donation that is to be considered a refund from the charity of prior donations made to the charity. The block 306 calculates the value of the donation after allowing for the refund and the value of any refund remaining from the charity. A block 308 determines if any donation amount remains after allowing for the refund and if so control passes to the block 304, otherwise, control passes to a block 310.

The block 304 determines whether amount of escrow that has already been withheld (escrow_held) is equal to the amount of escrow that is required to be withheld for the charity (escrow_required) and, if so, control passes to a block 312, otherwise control passes to a block 314 The block 314 calculates the amount of escrow that still needs to be withheld (escrow_rem). The block 314 also allocates up to an amount identical to the value of the variable escrow_rem from the donation amount to the escrow and adjusts the value of the variable escrow_held accordingly. In addition, the block 314 subtracts the amount of the donation applied to the escrow from the donation amount. Thereafter, a block 316 checks whether any donation amount remains after accounting for the escrow amount. That is, if the donation amount is greater than zero, control passes to the block 312. Otherwise, control passes to the block 310.

At the block 312, the donation processor 100 determines the payment method that is used to send donations to the charity using the payment methods described above. After the payment method is determined, control passes to a block 318 that provides payment to the charity in accordance with the payment method. Thereafter, the block 310 updates the charity information in the database 104 including the donation made to the charity, any refund amount remaining, the amount of escrow remaining to be withheld and the like.

If the relationship between operator of the donation processor 100 and a particular charity is severed, any donations withheld in escrow associated with such charity may be disbursed. In some embodiments, such donations may be released to the charity. In other embodiments, the donations may be divided among other charities that, for example, that have a mission similar to the particular charity. In still other embodiments, the donations may be divided among all of the other charities that receive donations through donation processor.

In some embodiments, donations associated with a purchase of an item made by a consumer are held in escrow only until the last date when such item may be returned for refund. Any escrow that has been accumulated for such items may be released or may be applied to future purchases of items.

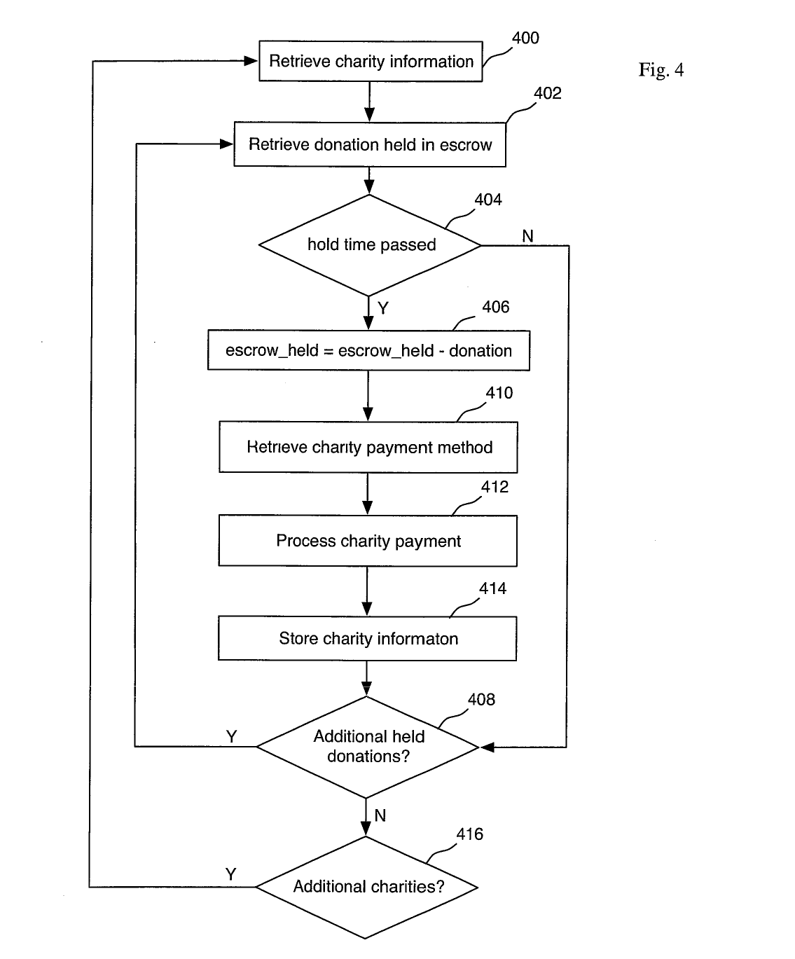

FIG. 4 shows a flowchart that illustrates daily processing by a donation processor 100 to release donations that do not need to be held in escrow because such donations are the result of purchases which may no longer be returned. A block 400 retrieves information regarding the charity. A block 402 retrieves information regarding a donation that is held in escrow. The information regarding the donation includes the date of the donation and the amount of time the donation is to be held in escrow.

A block 404 determines whether the amount of time the donation is to be held has passed and if so control proceeds to a block 406, otherwise control proceeds to a block 408. The block 406 reduces the amount of escrow held for the charity by the amount of the donation released. A block 410 retrieves the payment method associated with the charity and a block 410 processes the payment of the donation to the charity. In some embodiments, the blocks 410 and 412 operate in a fashion identical to the blocks 312 and 318, respectively, of FIG. 3. A block 410 thereafter updates the charity information to record the reduced escrow amount and the released donation.

A block 408 determines if additional donations to the retrieved charity need to be processed and, if so, control proceeds to the block 402. The blocks 402 through 408 are iterated until all donations that are held for the charity have been processed.

A block 416 determines if there are additional charities for which donations have been withheld and, if so, control passes to the block 400. The blocks 400 through 416 are executed in the manner described above until all of the charities in the donor database 104 have been considered.

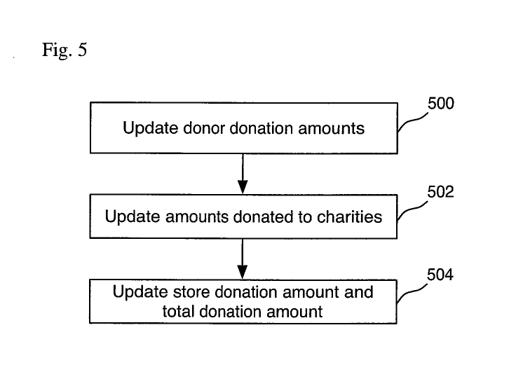

As described above, the donation processor 100 may feed information to a social network server 108 that provides a portal for a community of members interested in charitable contributions or community service. Such information may also be displayed to the public using a dashboard that tracks donations made via the store associated with the donation processor 100. Such dashboard may be accessed as a dynamically updated web page via the Internet or the cellular network. The donation processor 100, in substantially real-time, updates the information that may be displayed by the dashboard. FIG. 5 illustrates a flowchart of the information that the donation processor updates to allow dynamic generation of the dashboard. A block 500 updates amounts of donations generated by each consumer, a block 502 records amounts donated to each charity, and a block 504 records the donations made by the store and, if applicable, by a group of stores associated with the donation processor 100 or every member of the social network who provides donations.

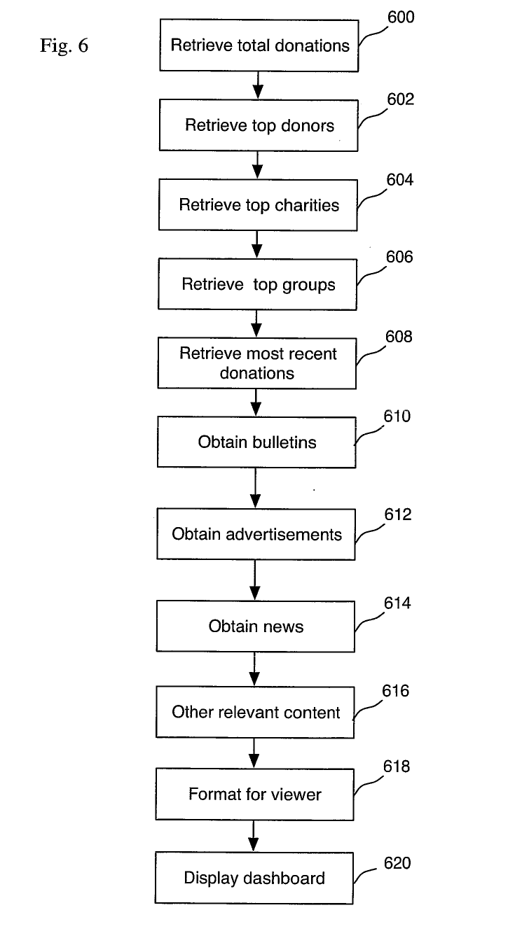

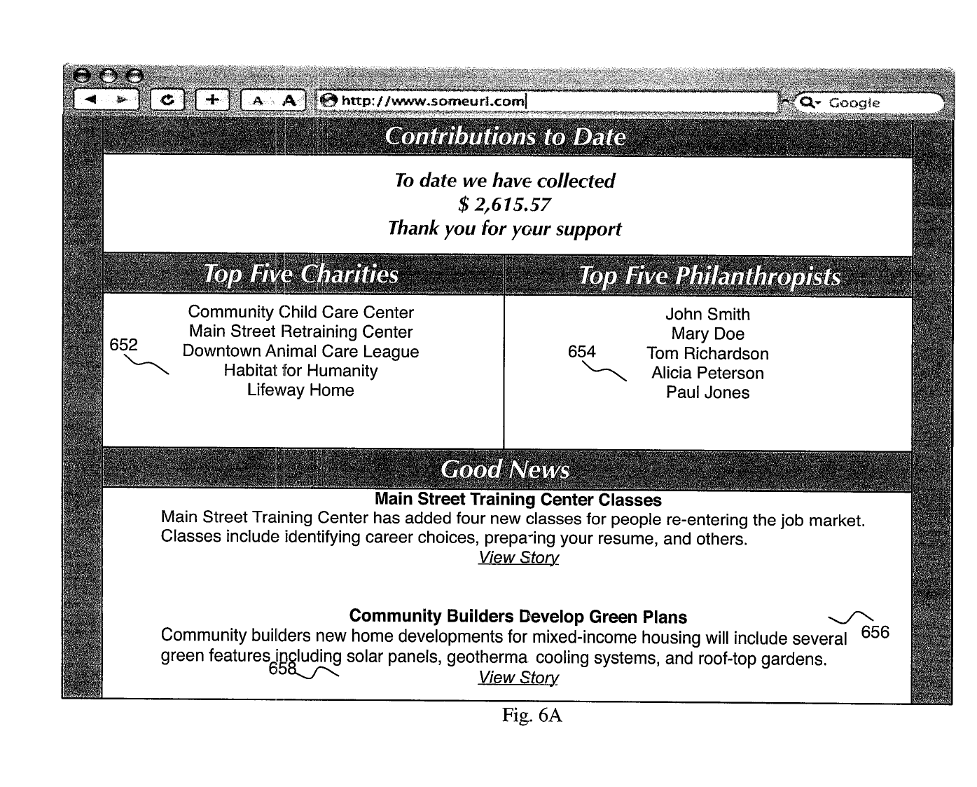

FIG. 6 shows a flowchart of how the donation processor 100 may generate a dashboard. A block 600 retrieves from the donor database 104 the total donations made by a store, a group of stores, individuals, consumer groups, or organizations. A block 602 retrieves from the donor database 104 information regarding consumers who have made the most donations. A block 604 retrieves from the donor database 104 information regarding charities who have received the most donations. A block 608 retrieves information regarding donations made most recently.

In addition to donation information, the dashboard may show information that may be of interest to the members of the social network. Such information is retrieved by blocks 610 through 616 from sources external to the donation processor and may include, respectively, bulletins regarding events related to charities or community service, advertisements of interest to members, news items of interest to the members, and other relevant content (including user generated content such as audio recordings, web pages, or videos). The information retrieved from the donor database 104 by the blocks 600 through 608 and received from external sources by blocks 610 through 616 is formatted for display on a web page and/or a mobile device by a block 618. A block 620 displays the formatted dashboard, for example, on a screen of computer used by a member of the social network. In some embodiments, members of the social network are consumers who have purchased items at stores (e.g., physical, electronic, or catalog retailers or service providers) associated with the donation processor. As such, as described above, the purchase and donation histories of such members are recorded in the donor database 104.

FIG. 6A shows an example of a web page that may be presented to members of the social network when such members access a web page using the Internet or the cellular network that presents the dashboard. The web page has an area 650 that displays the total amount of money collected by the members of the social network, an area 652 that shows the top five charities that have received donations, an area 654 that displays the top five donors (philanthropists). The web page also includes areas 656 and 658 that display news and information that may be of interest to members of the social network.

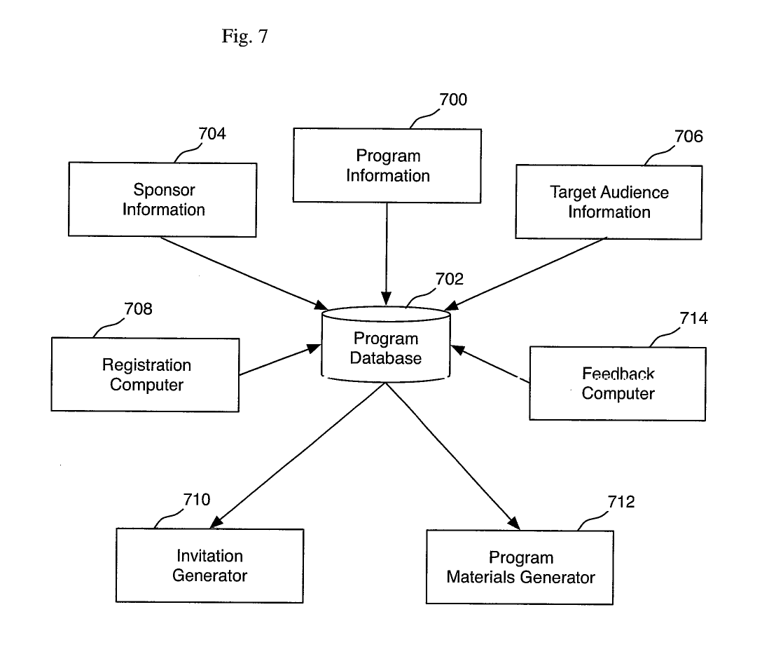

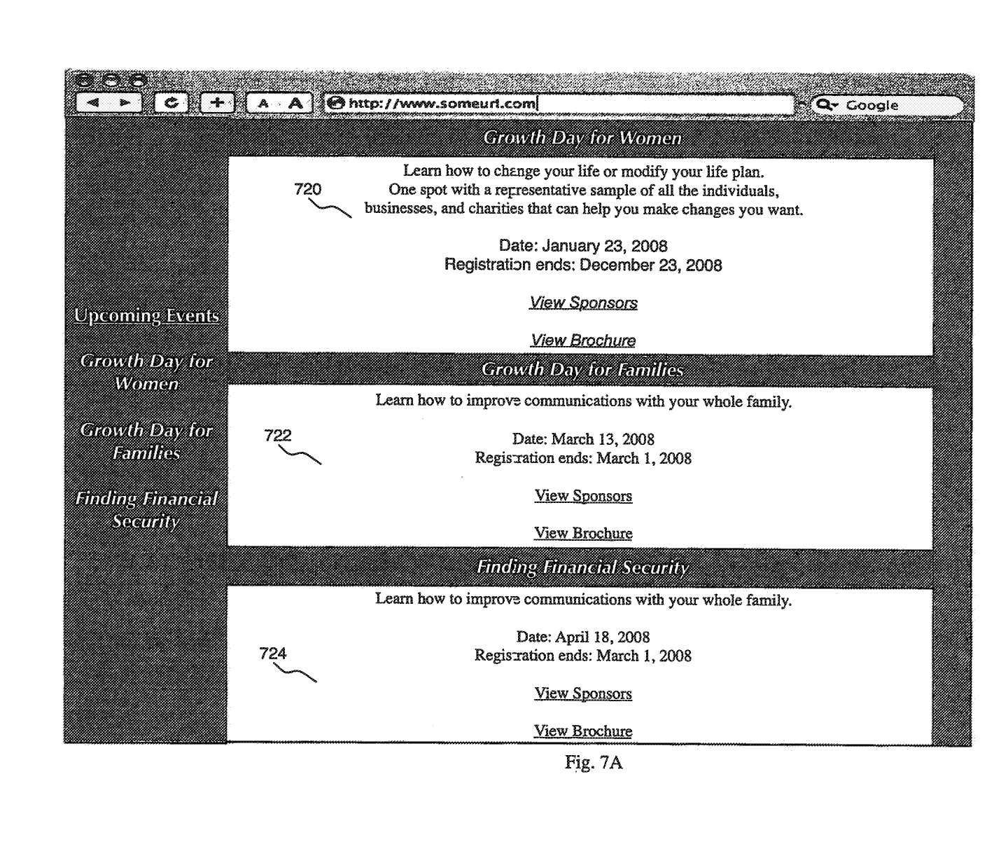

The members of the social network and other participants may be included in programs related to self improvement, community service or charitable donations. In some programs, members of the public not affiliated with the social network may also be invited. For example, the members of the social network may be invited to informational sessions or may be selected to provide a presentation to other members. FIG. 7 shows how a program database 702 may be created to facilitate such programs. In some embodiments, the donation database 104 is a part of the program database 702. In other embodiments, the donation database 102 and program database 702 synchronize data therebetween. In still other embodiments, the donation database 104 and the program database 702 are identical. Information regarding a program may be entered into the database by an organizer from a computer 700 used thereby. Similarly, sponsors of the program may enter information into the program database using a computer 704, such information may include topics for programs the sponsor is willing to subsidize, names of affiliates thereof, and charities donated to thereby. The sponsor and/or organizer may enter information regarding the target audience using a computer 706 that describes, for example, the interests of the target audience, community service activities of the target audience, the types of charities donated to by the target audience, skills of target audience, etc. An invitation generator 710 uses the information in the program database to identify people who may be invited to the program. In some embodiments, the invitation generator 710 may develop a list of invitees that may be used by the organizer. In other embodiments, the invitation generator 710 may compose and send e-mails to the invitees or generate personalized mail that is sent to the invitees. A program materials generator 712 uses the information in the program database to generate brochures and handouts that are provided to presenters at the program or to attendees at the program. In some embodiments, the program generator 712 generates data that may be sent to a printer to generate hard copies of brochures and handouts. In other embodiments, the program generator 712 may create electronic presentations that may be projected during the program.

Before commencing the program, attendees may be asked to provide registration information to a registration computer 708 that queries each attendee of the program regarding the interests, needs, skills, and the like thereof. The registration computer 708 records information provided by each attendee into the program database 702. At the conclusion of the program or at some time before an attendee leaves the program, a feedback computer 714 queries the attendee about relevance of the program thereto. The feedback computer 714 records any information gathered from the attendee into the program database 702. The information collected and recorded by the registration computer 708 and the feedback computer 714 into the program database may be used by the invitation generator 710 to identify invitees to further programs, by the organizer of the program to identify other subject areas that may be of interest to the target audience, and to provide feedback information to the sponsor.

FIG. 7A shows a web page of an Internet site that may be used to promote programs to interested participants and/or to members of the social network describe above. The web page includes areas 720, 722, and 724, each of which displays information about a program being presented. Each such area also includes a hyperlink where the viewer of the web page may obtain additional information about the program. For example, the area 720 that shows a program for a “Mom's Day” event includes a hyperlink 726 to information regarding the sponsors of the “Mom's Day” event and also a hyperlink 728 where the viewer of the web page may obtain a brochure describing the event. The sponsor information is generated from information entered into the program database 702 from the computer 704 used by the sponsor. The brochure may be a web page or an electronic document (for example, a PDF document) generated by the program materials generator 712. In some embodiments, the hyperlink 728 may lead the viewer of the web page to a form that may be used to request a paper copy of the brochure, wherein the paper copy may be generated from layout files created by the program materials generator 712.

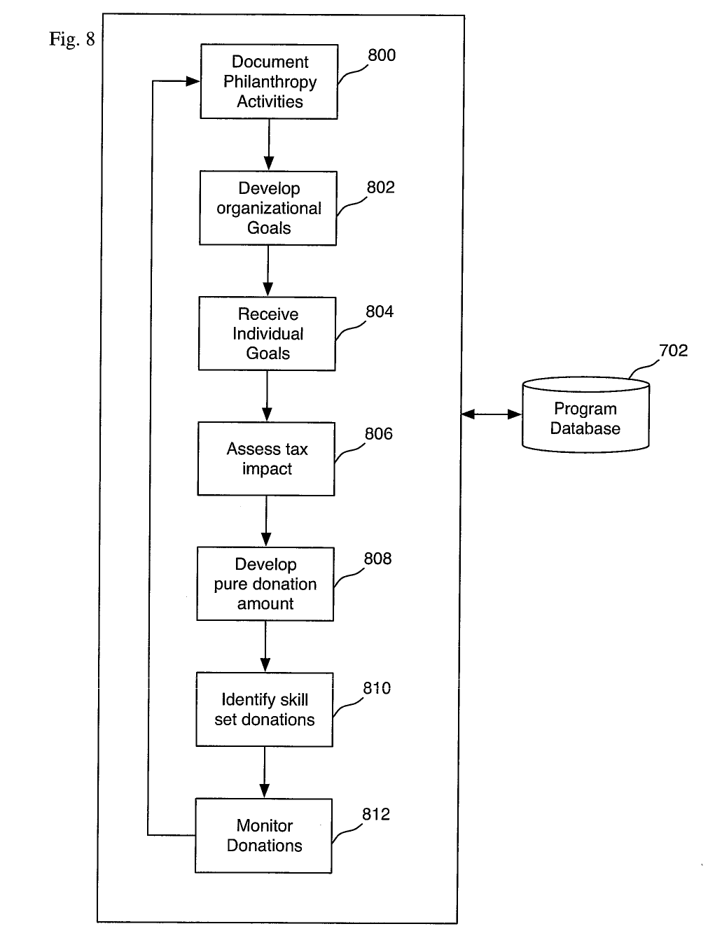

Companies, organizations, and other entities have organized donation campaigns to collect funds for charitable causes. Often such campaigns are ad hoc and may include only one charity or only provide donations in one form (e.g., food, money, etc.). Companies and their employees generally have other types of donations that they can make, for example, training others, facilities, etc. FIG. 8 shows a flowchart of how companies may organize donation campaigns thereof, provide data for the program database 702 that can be used to execute campaigns, and maximize any tax benefits that may accrue from donations. For example, the information collected from the company may be used to select the company as a sponsor of a program as described in FIG. 7.

A block 800 collects information about past and current philanthropic activities of the company. A block 802 develops organizational goals for providing contributions. The block 802 may present managers at the company with surveys to indicate recipients of donations that would be aligned with the goals of the company and/or the needs of the community where the company operates. The block 802 may also query managers about waste and by-products generated by the company that may be of value to another organization. For example, a paint company may have batches of paint that are usable but cannot be sold because the color of such paint may be outside of the tolerances of paint sold thereby. Such un-saleable paint may be usable in a homeless shelter or a day care center. A block 804 receives goals of individual employees of the company. The block 804 requests from each employee information regarding the recipients of donations that would be aligned with company goals and/or the needs of the community where the employee resides. The employees may also be queried regarding by-products or waste products that are disposed by the company.

A block 806 evaluates the past activities, organizational goals, and individual goals to estimate the tax impact of various donation options. A block 808 develops amount of donations that should be made either in funds or goods (e.g., from waste products or by-products) or labor provided to a charity. The block 808 uses information from the program database 702 to identify charities whose goals are aligned with the goals of the company and the employees of the company.

A block 810 identifies skills or know-how of employees at the company that may be donated to a charity. The block 810 uses the information in the program database 702 to identify charities who may benefit from the skills the employees of the company have and whose goals are aligned with those of the company and the employees.

For the program to generate ongoing contributions and to ensure such contributions are aligned with the goals of the company and employees thereof, a block 812 monitors the donation process and periodically evaluates goals, the tax impact, and identifies donations opportunities for the company

As described above, information about the company entered into the program database 702 may allow the company to provide a donation in the form of sponsoring an event such as providing training to the unemployed, providing counseling to students making transitions into high school or college, providing training to entrepreneurs, providing training to parent for resolving family issues, family or team building, and the like. Such sponsorship opportunities may be identified through the goals analysis shown in FIG. 8 and may be implemented using the program development described in connection with FIG. 7.

Another type of donation opportunity that may be identified for the company and the employees thereof includes a direct giving program. Each employee may be provided with a way to collect spare change, for example, a piggy bank. Once the piggy bank has been filled or after a pre-determined period of time expires, the employee may return the piggy hank to the company and the contents of the piggy bank may be donated to a charity using the donation processor 100 described hereinabove.

The goals information provided by the company and entered into the program database 702 may be used to identify a community that may benefit from services provided by the company, facilities operated by the company, franchisees affiliated with the company, and the like. A community rebuilding system may be used to generate a plan for bringing businesses and other organizations into the community that are aligned with the goals of the community and that sell products that may be of interest to members of the community. Furthermore, a community rebuilding system may use the information in the program database 702 to identify such a community. The community rebuilding system may also identify potential franchisees of the company.

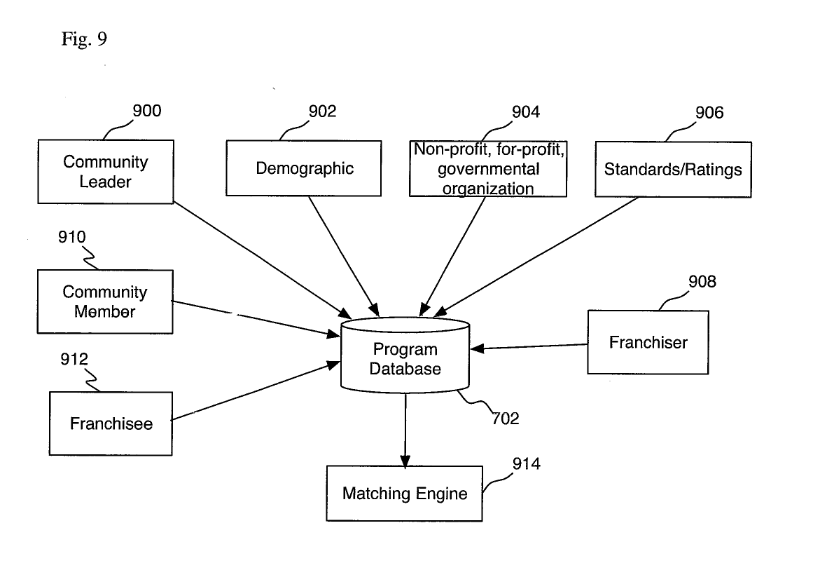

FIG. 9 shows elements of an embodiment of a community building system. The community building system presents a survey on computer 900 used by a community leader, for example, using a web form. The survey allows the community leader to enter data regarding the needs of the community as perceived by the community leader. The data entered at the computer 900 used by the community leader is entered into the program database 702. The community leader may enter information regarding demographic goals thereof such as a target mean or median income, target home price, housing stock, family size, educational system and institutions, and the like and such data is entered into the program database 702. The community leader may also enter information regarding incentives the community may be able to provide potential companies who locate in the community (tax benefits or community owned land, leases on community owned real estate, tax increment financing districts, eminent domain options).

The community rebuilding system may obtain current demographic information from demographic and census information sources 902 such as those provided by the U.S. Census Bureau. The community rebuilding system may allow a member of a non-profit group, a for-profit group, or a governmental organization to use a computer 904 to enter data into the program database 702 regarding the goals thereof and/or the community, services provided thereby, and the skills and donations that are needed by the non-profit group and/or the community. The community rebuilding system may obtain information from a standards and ratings system 906 such as a credit rating agency and enter such information into the program database 702. Such information may include, for example, a social indicator index.

As described above, a company that is a franchiser may use a computer 908 to enter information about itself into the program database. For example, the franchiser may allow the community rebuilding system to access a computer or a web site operating on a computer 912 thereof to obtain, for example, a Franchise Disclosure Document and criteria for selecting franchisees. For example, the franchiser may provide information regarding average consumer markup, average startup costs, products and services offered, and organization location and placement data.

The community rebuilding system may allow a community member to use a computer 910 thereof to complete surveys regarding their opinions on the needs for the community and the services and stores lacking in the community that they would use. Such information entered into the computer 910 by the community member is also added to the program database 702.

The community rebuilding system may obtain information regarding potential franchisees either by requesting that the potential franchisee use a computer 912 thereof to enter data into the program database. However, potential franchisee information may also be collected from attendees who register for programs directed at franchisees and entrepreneurs. In such cases, the computer 912 used to enter franchisee information may be identical to the registration gatherer 708. A matching engine 914 uses the information entered into the program database 702 to identify franchises that meet the community needs identified by the community leader, community member, non-profit groups in the community and the like. The matching engine 914 also uses the information in the program database 702 to identify entrepreneurs who may be candidates to obtain franchisees.

FIG. 9A shows a web page that may be provided on the computers 900 or 910 used by a community leader or a community member, respectively, to collect information regarding the vision of the such users and the needs perceived by such users. For example, an area 920 of the web page allows the user to enter targets for the population, average income, family size, and average home price that user feels would be desirable. In addition, an area 922 allows the user to select from a number of needs that are perceived as important by the user. A similar web page may be provided at the computer 904 to solicit information from non-profit group, for-profit groups, and governmental organizations.

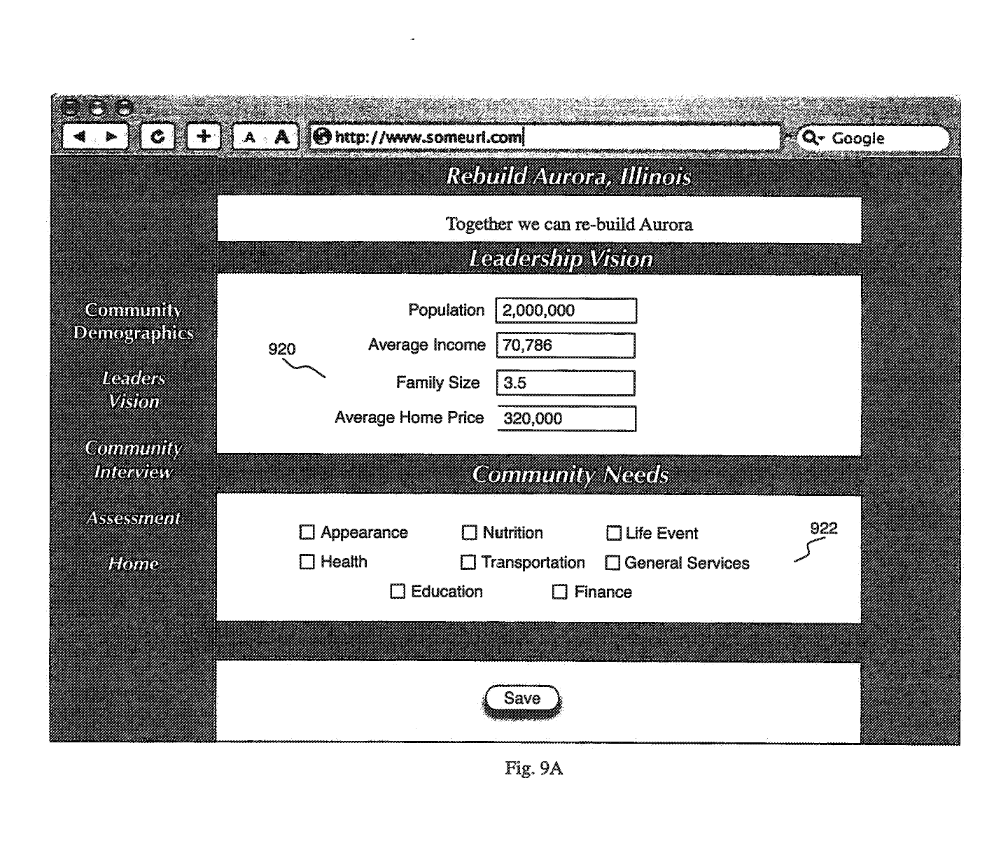

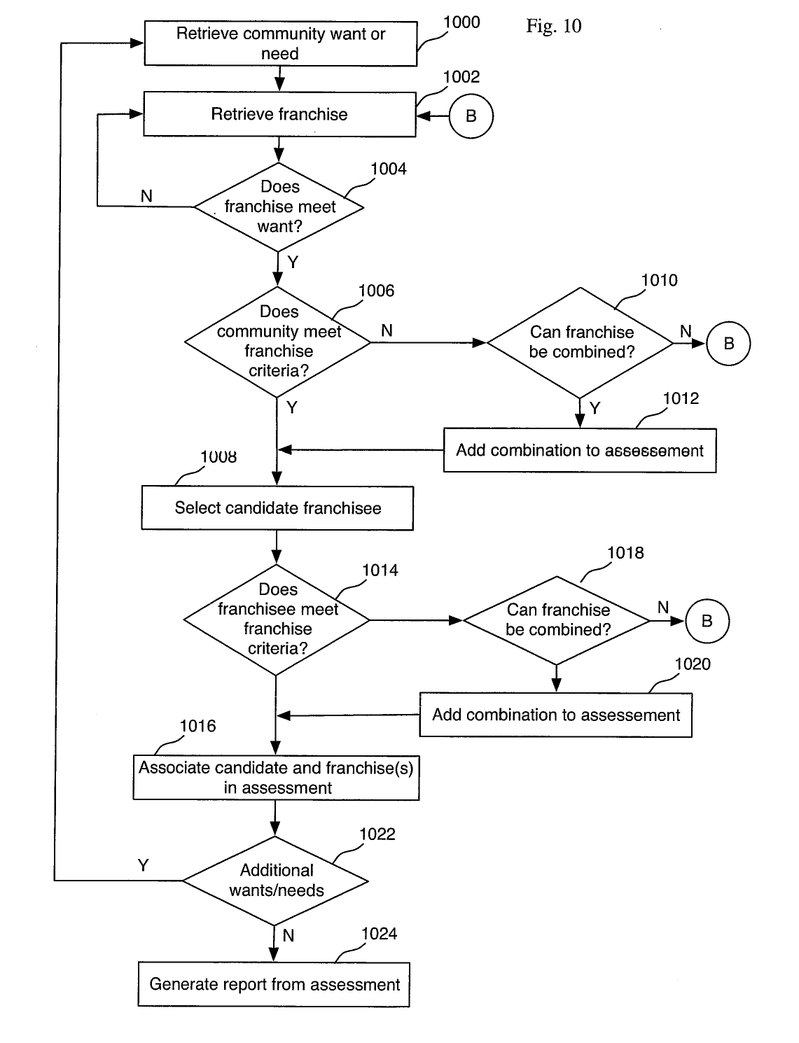

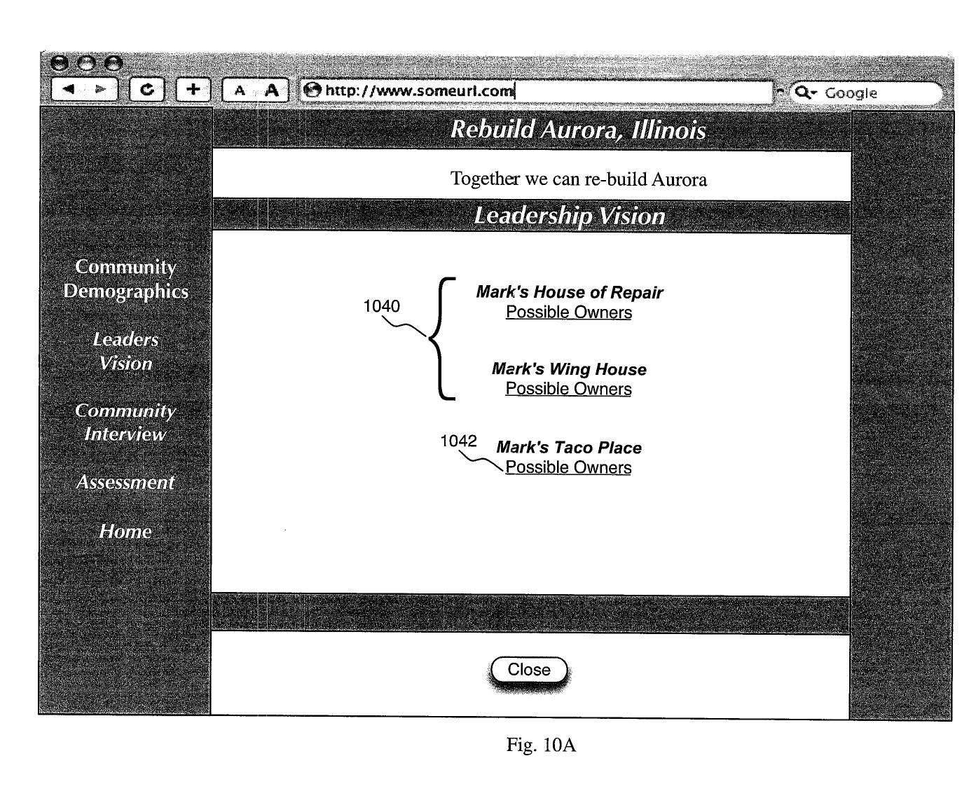

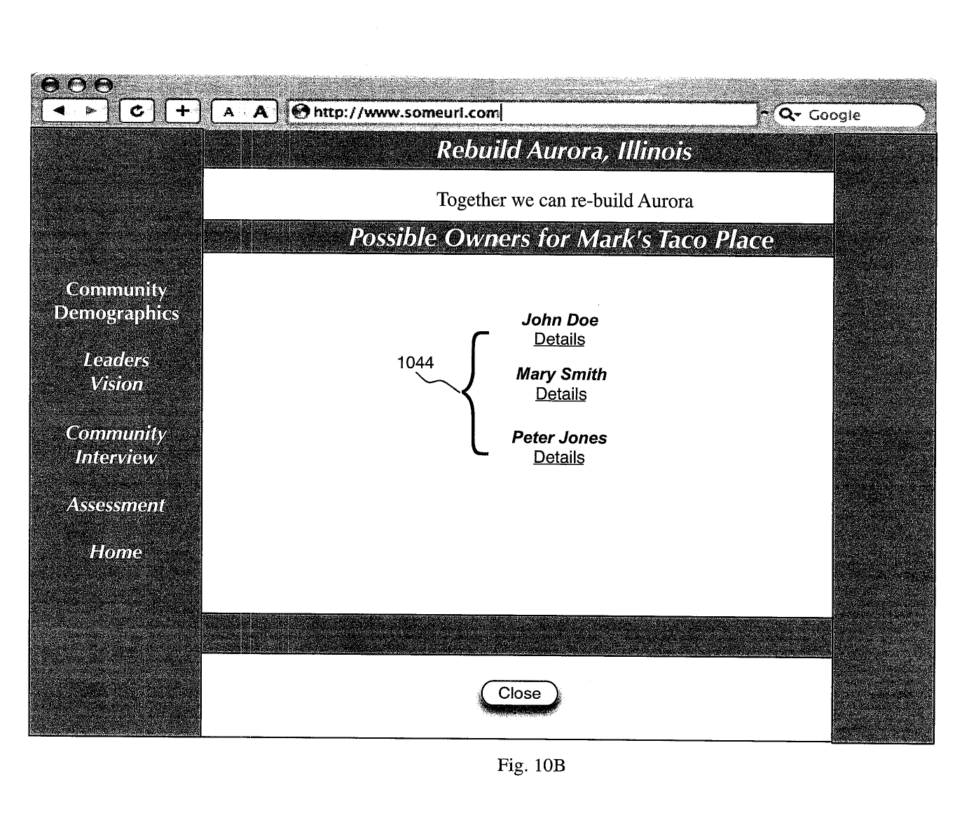

FIG. 10 depicts a flowchart of how one embodiment of the matching engine may operate. A block 1000 retrieves from the program database 702 community wants and needs entered by the community leader and by one or more community members. The wants and needs may be ordered in accordance with the number of people who selected each want or need. Alternately, the wants and needs may be ordered in accordance with the status of the person who entered each want or need. A block 1002 retrieves franchise information that represents a franchise from the program database 702. A block 1004 analyzes the franchise information to determine if the franchise represented thereby meets the want or need retrieved by the block 1000, and, if so, control passes to a block 1006. Otherwise, control returns to a block 1002 to retrieve information regarding another franchise. Blocks 1002 and 1004 iterate in this fashion until information is retrieved about a franchise that meets the want or need or until all of the franchises in the program database 702 have been considered with respect to the want or need retrieved by the block 1000.

The block 1006 compares the demographics of the community with the criteria for the franchise to determine if the community meets such criteria and if so control passes to a block 1008, otherwise, control proceeds to a block 1010. The block 1010 determines if the franchise may be combined with another franchise in the database, where the community may meet the requirements of the combined franchise. For example, the community may not have sufficient demand to support an ice cream franchise through an entire year because of seasonal variation in demand for ice cream. However, combining the ice cream franchise with a coffee franchise may produce a combined franchise with less seasonal variation in demand such that the community may be able to meet the demand criteria of the combined franchise.

If the block 1010 determines that combined community does meet the criteria of the combined franchise, control passes to a block 1012 that adds the combined franchise to an assessment report. Otherwise control passes to the block 1004 to retrieve another franchise. After the block 1012 control passes to the block 1008.

The block 1008 selects candidate franchisees who have expressed an interest in the products or services offered by the franchise. A block 1014 determines if the candidate franchisee meets criteria for potential franchisees established by the franchise, and if so, control passes to a block 1016. Otherwise, control passes to a block 1018 that determines if a combined franchise can be identified as described above, wherein the franchisee may meet the criteria of the combination. If such a combined franchise is identified, control passes to a block 1020 that adds the combination franchise to the assessment report. Thereafter, control passes to the block 1016.

The block 1016 adds the candidate franchisee to the assessment report and associates the candidate franchisee with the franchise or combined franchise selected by the block 1002.

The block 1022 determines if there are additional wants or needs in the program database 702 that have not been considered and, if so, control returns to the block 1000. Otherwise, control proceeds to a block 1024 that generates a report that memorializes the results of the assessment. The report may indicate franchises and candidate franchise owners therefor who may improve the community and who may benefit from investing in the community.

In some embodiments, the block 1024 generates data that may be sent to a printer to generate a printed report. In other embodiments, the block 1024 generates the report as an electronic document such as a PDF or a collection of web pages. FIG. 10A shows an example of a web page that may be generated by the block 1024. The web page shows a list 1040 of franchises that may contribute to the improvement of the community. For each business in the list, the web page provides a hyperlink, for example, the hyperlink 1042, to information regarding franchisees selected as qualified to operate such business. Selecting the hyperlink leads to a page illustrated by FIG. 10B that displays a list 1044 of qualified franchise owners. Associated with each qualified franchise owner is a hyperlink (for example, the hyperlink 1046) that leads to further information about the qualified franchise owner, in some embodiments the hyperlink leads to a page from the social network associated with the qualified franchisee.

It should be apparent that the matching engine 914 may be used to select businesses other than franchises that may help meet a communities needs. Businesses that wish to consider may provide information to the program database 702 using a computer 904. To select a non-franchise based business, the embodiment of the matching engine 914 works essentially identically as when selecting a franchisee, except 1014, 1018, and 1020 may not be necessary.

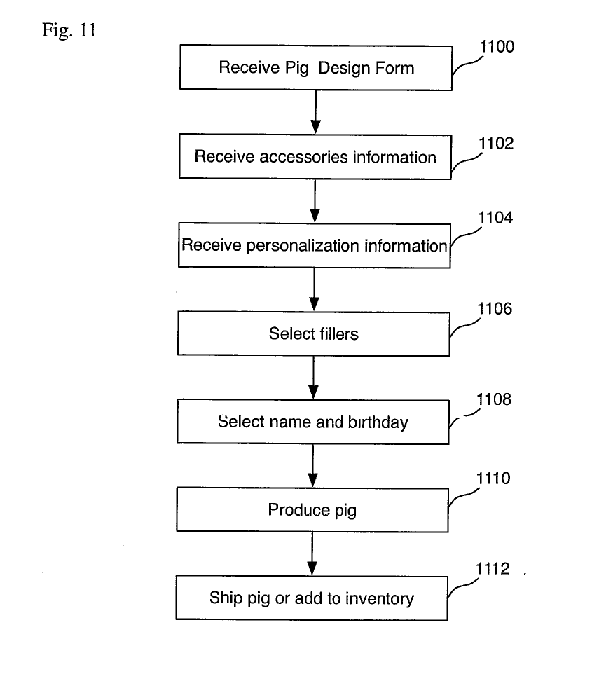

The retail stores (either physical stores, stores accessed electronically using the Internet or the cellular network, or cataloger stores), and corporate donation programs described above may allow people to accumulate money that may be donated. Alternately, such stores and programs may sell personalized items to a consumer and the proceeds from the sale may be used to generate donations as described above in connection with the donation processor 100. FIG. 11 shows a flowchart of producing an item to be sold, for example, a container shaped like a pig that may be customized for the consumer. A block 1100 receives a design form that indicates the design the consumer wishes for the pig shaped container. A block 1102 receives information regarding accessories that may be used to customize the pig shaped container. Such accessories include imprinted decorations of sport themes or corporate logos, jewelry, clothing, and the like. A block 1104 receives personalization information regarding the recipient of the pig shaped container. A block 1106 allows the consumer to select items that may be added to the pig shaped container such as candies, hard products such as toys, dolls, baby items, sports items or other sundries. A block 1108 allows the consumer to select a name and a birth date for the pig shaped container and may also allow the consumer to enter a name and birth date for the “parents” or recipient of the pig shaped container. A block 1110 generates a production order in accordance with the information collected by the blocks 1100 through 1108 and may schedule production of the pig shaped container. Thereafter, the block 1112 ships the pig shaped container to the recipient, the consumer, or places the pig shaped container into inventory for later purchase or pick up.

It should be apparent that the donation database 104 may be used by an operator of the donation processor to populate the program database 702. In some embodiments, the donation database 104 and the program database 702 are identical and are used to form a cohesive donation and information management system.

The program database 702 may also be used to identify individuals who have skills that can be provided as a donation for free or on a pay-per-use basis. The surveys and information collected from consumers of a store associated with the donation processor 100, members of the social network described above, registrants at a program, employees of a company that participates in the donation program, franchisees who participate in community rebuilding efforts as described above may include questions about their individual skills and interest in sharing such skills. In one embodiment, an application is executed on an access device such as a cell phone, a Blackberry device manufactured by Research In Motion of Waterloo, Canada, or an iPhone manufactured by Apple Computer of Cupertino, Calif., that may allow an individual to access skills of people who have provided information about themselves in the program database 702.

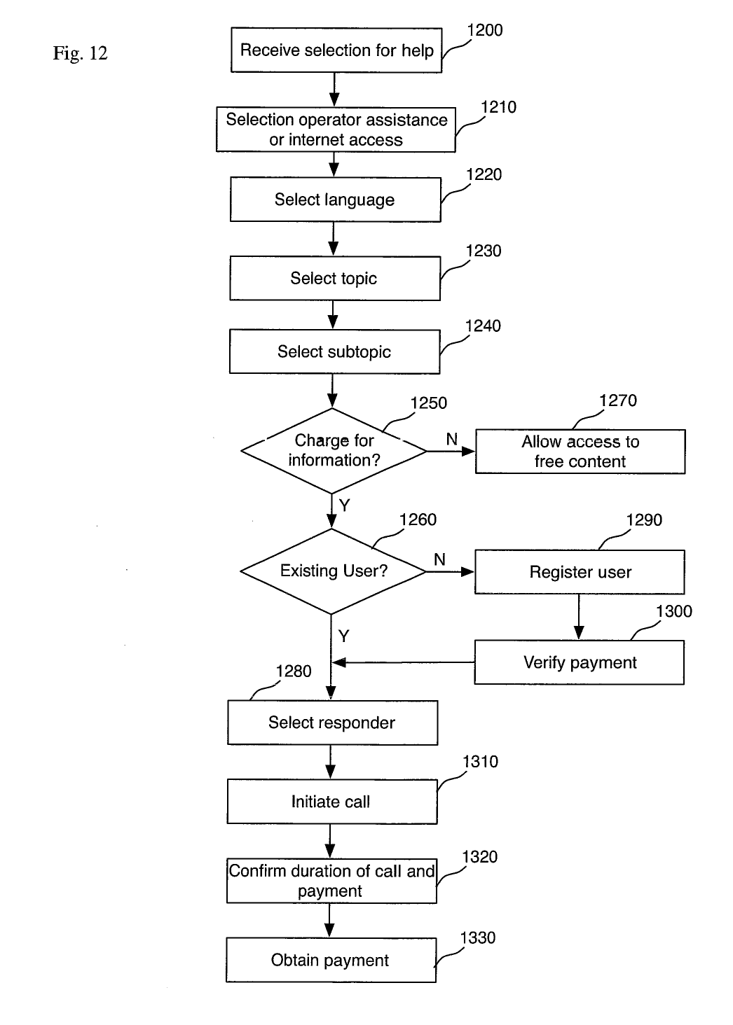

FIG. 12 shows a flowchart of one embodiment of an application that the individual may use to obtain access to such skills. A block 1200 receives from the individual a selection to access the skills. For example, the block 1200 receives the selection of an icon displayed on the access device used by the individual. Alternately, the block 1200 may be responsive to the access of an Internet web site by the individual. In some embodiments, the block 1200 may be responsive to receipt of a telephone call from the individual.

A block 1210 determines if the individual wants the assistance of an operator or wants to access the skills using the Internet. If the individual requests the assistance of an operator then an operator is contacted that guides the user through prompts described below that are presented to the individual. The operator may be human operator or an electronic operator that is responsive to verbal commands and/or presses of buttons on the access device.

A block 1220 allows the individual to select a language of communication preferred thereby. Any prompts presented to individual thereafter are presented in the selected language.

A block 1230 requests from the individual a topic being investigated thereby. Examples of topics include health, wealth, beauty and self care, and the like. In some embodiments, the block 1230 presents the individual with a list of topics from which to select one of the displayed topics, wherein the list is constructed from the skills of the people who are represented in the program database 702

A block 1240 requests from the individual a subtopic related to the topic selected by the block 1230 that further narrows the area of assistance sought by the individual. For example, if the individual select the topic of health, the block 1240 may request that the individual select from a list of subtopics that include pet care, nutrition, life coaching, and the like.

A block 1250 queries the individual to determine whether the individual is willing to pay for information or wants to access information that is free. If the individual is willing to pay for information, control passes to a block 1260, otherwise, control proceeds to a block 1270. The block 1270 allows the user access to free content such articles or links to web sites. In some embodiments the block 1270 may connect the individual to a volunteer who has agreed to provide free information. In some embodiments the individual may be provided with the ability to draft an e-mail message to the volunteer and in other embodiments the individual may be allowed to telephone the volunteer.

The block 1260 determines if the individual is an existing user of the system and if so control passes to a block 1280. Otherwise, control passes to a block 1290 that allows the individual to register with the system. In some embodiments, the block 1290 collects information identifying the individual and payment information. Thereafter, a block 1300 verifies that the payment information provided by the individual is valid and, in some embodiments, that sufficient funds are available. Examples of payment methods that may be used by the individual include a payment service such as PayPal, an electronic funds transfer, a pre-paid account, or a wire transfer. After payment information is obtained, control proceeds to the block 1280.

The block 1280 identifies and selects a responder from the program database 702 who has been identified as having skill in the topic and subtopic. If more than one responder is identified with such skill, one embodiment of the block 1280 may select one responder from the identified responders in a round-robin fashion. In another embodiment, the block 1280 selects one responder from the identified responders in accordance with the distance between the responder and the individual seeking assistance. In still other embodiments, the block 1280 selects one responder from the identified responders in accordance with the amount of time each responder has spent assisting individuals over a period of time, for example, selecting the responder who has spent the least amount of time. In some embodiments, providers who have agreed to provide services at a lower cost may be selected more often than, others. In other embodiments, a provider is selected in accordance with the geographic distance between where the provider is located and where the individual requesting information is location.

A block 1310 initiates a telephone call to the responder selected by the block 1280. If the responder cannot be contacted and the block 1280 identified more than one responder, the block 1300 may select another responder to contact. In other embodiments, the individual may be allowed to send an e-mail to the selected responder or to leave a voice mail message thereto.

After a telephonic connection is made between the individual and the selected responder by the block 1310, a block 1320 times the duration of the telephone call. The block 1320 thereafter confirms the duration of the telephone call with the individual and/or the responder, calculates the payment to be obtained from the individual. The amount of the payment may be a fixed charged based on the topic and subtopic selected by the individual. In other embodiments, the amount of the payment may be based on the expertise of the selected responder. In still other embodiments, the amount of the payment may be based on a per-minute rate multiplied with the duration. Some embodiments combine a fixed charge, the expertise of the responder, and a per-minute rate multiplied with the duration of the call to calculate the amount of the payment. The formula used to calculate the amount of the payment may be varied in accordance with the topic or sub-topic selected by the individual. For example, topics/sub-topics deemed more complex may use both a fixed rate and the expertise of the responder to calculate the amount of the payment or the services may be donated.

After the amount of the payment is calculated, a block 1330 obtains payment from the payment method selected by the individual at the block 1330.

In some embodiments, a program database 702 may be populated for a particular community or an entity, such as a company. For example, a company may identify subject matter experts as skilled providers in the program database 702. Employees of the company may obtain information or assistance from such providers as described above in connection with FIG. 12, for example. In some embodiments, information about employees who have excess capacity may be entered into the program database 702, and individuals or departments within the company may access the services of such individual as described above. The company may determine the form in which payment should be provided. For example, all services may be acquired without charge. Alternately, payment may be provided in services or as an intra-company transfer of budgeted or actual funds.

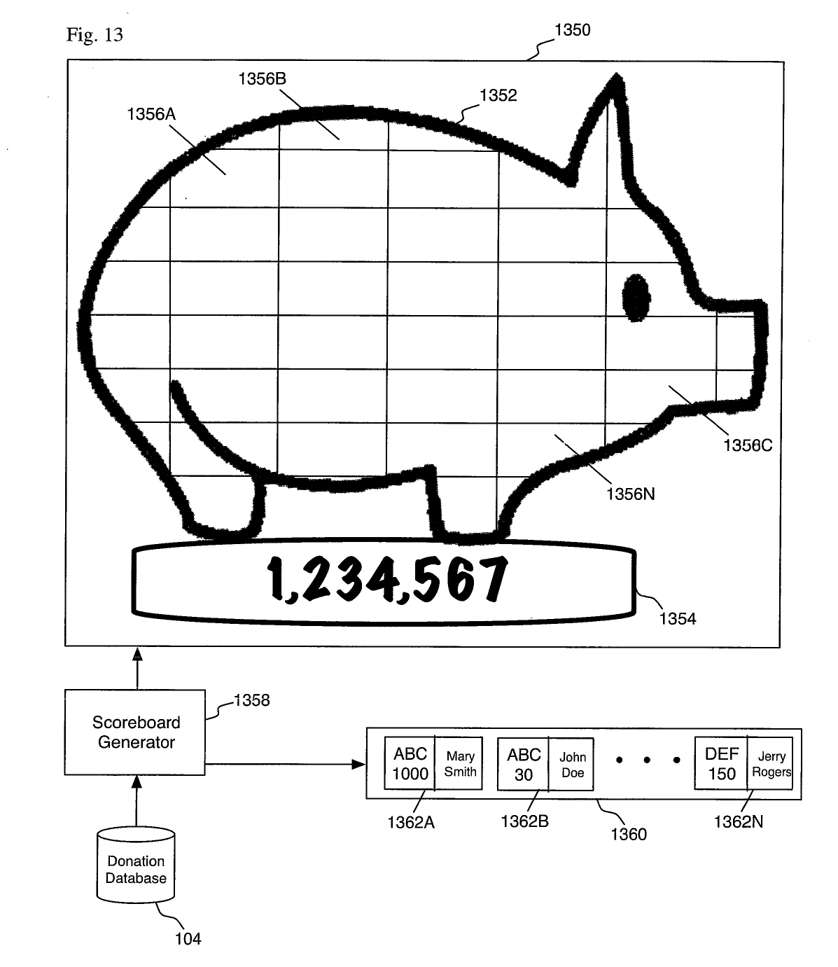

The aggregate value of the donations collected as described above may be depicted on a display. Such a display may include an electronic scoreboard (such as that used at sporting events, a billboard, a television display, an image displayed on a web site, and the like). The display may be dynamic and updated in substantially real-time. FIG. 13 depicts an example of such a display 1350 that comprises an image of a pig 1352 and a tally region 1354. It should be apparent that any image may be selected instead of the pig. The image of the pig 1352 is divided into regions 1356A, 1356B, 1356C, . . . 1356N. A donation made by an individual or an organization may be indicated using one of the regions 1356A, 1356B, 1356C, . . . 1356N. For example, the size of the region 1356A, 1356B, 1356C, . . . 1356N depicted on the image of the pig 1352 may be in accordance with the value of the donation compared to the other donations depicted by the image of the pig 1352. In addition, the region may indicate information regarding the donation such as the name of the donor, the value of the donation, where the donation was made, the date and time of the donation, and the like. Because the display 1350 is updated dynamically, an individual may make a donation (e.g., through a purchase at a physical store, via the Internet, or using a cellular device) and have a representation of that donations appear in one of the regions 1356A, 1356B, 1356C, . . . 1356N.

The tally region 1354 is used to indicate an aggregate value of donations received. In one embodiment, the tally region 1354 may show the value of total of the donations in currency (e.g., dollars). In another embodiment, the tally region may show the total weight of the donations (e.g., the weight of the penny coins equivalent to the total value of the donation).

A scoreboard generator 1358 may dynamically create the image of the pig 1352 and the tally 1354 displayed in the display 1350 from data provided by the donation database 104. For example, each time a donation is made and the donation database 104 is updated as described above, the scoreboard generator 1358 generates a new image that is to be displayed on the display 1352. In some embodiments, the scoreboard generator may create the entire image 1352 and, in other embodiments, the scoreboard generator may create images for those regions that are affected by the donation.

Information regarding donations may be depicted using a ticker display, for example, display 1360 that shows, in substantially real-time, donations made by individuals or organizations. The scoreboard generator 1358 may generate data (e.g., one or more images or the text) that are displayed in the ticker display 1360. The ticker display 1360 comprises indicators 1362A, 1362B, . . . 1362N that show donations that have been made. In one embodiment, the ticker display 1360 shows indicators 1362A, 1362B, . . . 1362N for all of the donations made during a predetermined period of time. In another embodiment, the ticker display 1360 shows an indicator for a predetermined number of donations. If the space required by the indicators 1362A, 1362B, . . . 1362N, for donations displayed in the ticker display 1360 exceeds the space available in the ticker display 1360, the indicators 1362A, 1362B, . . . 1362N may scroll to make other indicators visible.

As with the display 1350, each indicator 1362A, 1362B, . . . 1362N may indicate information regarding the donation represented thereby such as the name of the donor, the value of the donation, where the donation was made, the date and time of the donation, and the like. Because the ticker display 1360 is updated dynamically, an individual may make a donation (e.g., through a purchase at a physical store, via the Internet, or using a cellular device) and have an indicator 1362A, 1362B, . . . 1362N representing such donation appear on the ticker display 1360. The scoreboard 1350 or ticker display 1360 may be a physical display that is installed in a public location such as a store, a mall, a gathering place, a park, and the like or a private location such an office or a home. In addition, the display 1350 or ticker display 1360 may be made available to viewers via the Internet (for example, a dynamically updated web page), the cellular telephone network (as a page or image displayed on a mobile device), or using a television channel that displays such content. In some embodiments each indicator 1356A, 1356B, . . . 1356N or 1362A, 1362B, . . . 1362N is associated with an individual donor and such indicator displays the total donations made by such donor. In other embodiments, each indicator is associated with an individual donation made by a donor and the display may have more than one indicator associated with same donor.

In some embodiments, the displays 1350 or 1360 may be interactive. For example, if such display is viewed using a web browser either using the Internet or the cellular network, the viewer may be able to select one of the indicators 1356A, 1356B, . . . 1356N or 1362A, 1362B, . . . 1362N, and in response to the selected the browser may be directed to a page in the social network associated with the donor who made the donation with which the indicator is associated. Such page is similar to the dashboard shown in FIG. 6A, except the page displays regarding the top charities to which the donor has contributed and information regarding the types of charities and causes in which the donor is interested.

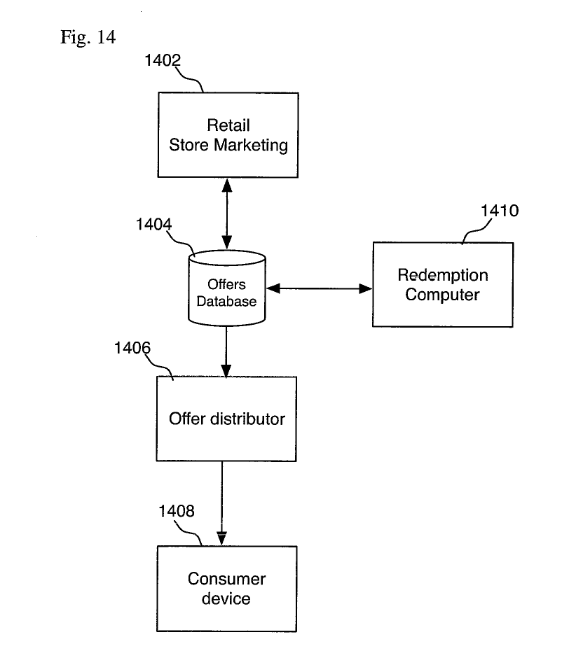

FIG. 14 depicts a system that may be used to distribute coupons and information regarding sales electronically to consumers instead printed direct mail. In particular, a retail store marketing system 1402 may identify discounts to provide to a consumer. The marketing system 1402 records information about such discounts and the consumer into an offers database 1404. An offer distributor 1406 periodically retrieves information regarding discounts from the offers database 1404 and sends such information to a device 1408 used by the consumer for whom such discount information is intended. The offer distributor 1406 may send the discount information to the device 1408 electronically using, for example, e-mail, an instant message, and/or by providing an icon on an Internet web site visited by the consumer using the device 1408. In some embodiment, the consumer who uses the device 1408 notifies the retail store regarding how discount information should be delivered to the device 1408. In other embodiments, the discount information is delivered to the device 1408 in accordance with the capabilities of the device 1408.

After the consumer retrieves the discount information from the device 1408 used thereby, the consumer may use a redemption computer at the retail store to obtain the discount. In some embodiments, the redemption computer 1410 that is physically located at a retail store and prints physical coupons that may be presented when making a purchase. In other embodiments, the redemption computer 1410 may be the cash register used by a checkout clerk at the store that electronically applies the discount to purchases made by the consumer. In such embodiments, the discount information may be retrieved from the offers database 1404 automatically after information regarding the consumer has been entered into the redemption computer. The information regarding the consumer may simply be identifying information about the consumer (name, frequent purchaser card, etc.) or may be a request by the consumer to redeem a discount received thereby.

In still other embodiments, the redemption computer 1410 may be associated with the checkout processing of an electronic commerce web site that the consumer may access with a device that uses the Internet or the cellular network. In such embodiments, the offer may be retrieved and redeemed upon identifying the consumer.

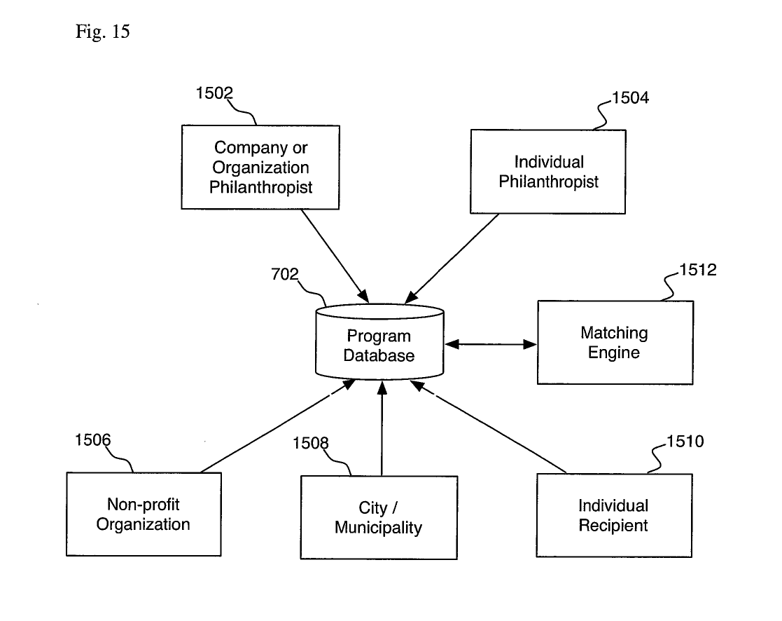

FIG. 15 shows a system that matches philanthropists with organizations and/or individual who may benefit from contributions made thereby. A staff member at a company or organization philanthropist uses a computer or mobile device 1502 to enter information regarding contributions the company wishes to make. Similarly, an individual philanthropist may use a computer or mobile device 1504 to enter information regarding contribution he or she wishes to make. Such information may be solicited from the company or organization philanthropist or the individual philanthropist using, for example, a web page that is displayed on the computers or mobile devices 1502 and 1504. Such information may include identifying information about the philanthropist, the type of contribution being made, and any constraints on the contribution (for example, if the contribution must be used within a certain period of time or in a particular locale). The types or contributions may include products, services, funds, skills, by-products, services, training, assets, facilities and the like. A non-profit organization may use a computer or a mobile device 1506 to enter contribution needs thereof. Similarly, a city or municipality or an individual may use a computer or a mobile device 1508 or 1510, respectively, to enter information regarding their needs. The information received from the computers 1502, 1504, 1506, 1508, and 1510 is stored in the program database 702. A matching engine 1512 compares requests received from devices 1506, 1508, and 1510 against the offers of contributions received from the devices 1502 and 1504 to identify any matches. When a match is found the recipient and the donor are notified and in some cases connected (e.g., via a chat, a telephone call, or e-mail) to allow communication therebetween to arrange for the donation to be provided to the recipient. The matching engine may also identify a service provider that can transport a donation from the donor to the recipient. In some embodiments, the service provider may be one who has volunteered such services. Further, the matching engine may send information regarding where to collect the donation, the donation, and/or the destination of the donation to the service provider on behalf of the donor and/or the recipient.

For example, a representative of a factory that manufactures paint may use the computer 1502 to enter information about excess inventory of paints. A representative of a day-care center that is beginning a remodeling project may use the computer 1506 regarding the materials needed for the project including paint. The matching engine matches the availability of the paint from the paint manufacturer with the needs of the day care center and notifies both organizations.

In another example, a representative of homeless support organization may enter information regarding the services offered thereby using the device 1502. A homeless person seeking assistance may use a device 1510 (for example, a telephone) to enter information regarding the assistance. The matching engine 1512 identifies the homeless support organization and connects the homeless individual therewith. The matching engine 1512 may be used to facilitate other types of connections described above, for example, those described in connection with FIG. 12.

Information regarding donation of time from individuals or organizations are tracked using the program database 702. Opportunities to make such donations may be provided using any of the embodiments described hereinabove in which information is collected from individuals or organizations including at a retail store, when registering for a program or providing information regarding participation in a program, providing information used to develop a corporate donation strategy, providing information related to community revitalization, and the like.

The program database 702 may also track usage of time donated by an individual or an organization. For example, if an individual with a particular skill donates 10 hours of time, such donation is recorded in the program database 702. If the individual who made the donation is thereafter connected with a recipient, for example, via a telephone call as described in connection with FIG. 12, and provides 3 hours of free consulting to the recipient, the use of the 3 hours is also recorded in the program database 702. When the web page of the social network associated with donor is displayed as described hereinabove, such web page may show the amount of time contributed by the individual and, in some embodiments the amount of time that has been used by one or more recipient(s).

In one embodiment, the program database 702 may track the value donations made by and received by users. The value of the donation may be tracked as points. Each point may be based on the monetary value of the donation or, if the donation is a service, the skill of the provider or the time and/or effort expended to provide the donation. Such points may be associated in the program database 702 with an individual or an entity depending on who provided the donation and/or points may be predetermined based on the type of provider, type of work, experience of the provider, and/or any other factors. In some embodiments the points may be transferred from one individual or entity to another individual or entity.

An individual or entity may use a point redemption system to redeem the points accrued thereby to pay for any of the above described services, activities, or events described above. For example, the points may be used to pay for any fees associated with being a member of the social network or to attend or sponsor an event such as “Mom's Day.” The points may be used to pay (for example, at the block 1330 of FIG. 12 described above) for information obtained from a skilled individual regarding a particular topic.

In some embodiments, an individual (or entity) may redeem the points in the form of a service card that may be given to another individual so that such individual may pay for services or participation in an event. In some embodiments, the service card may be associated with a particular service or event selected by the individual or entity. For example, an individual who has accrued points may convert some or all of the accrued points into a service card associated with receiving information and/or services directed to homeless persons such as counseling, shelters, health providers, and the like. The individual may present such card to a homeless person who can then use the service card to access such services from an agency that assists the homeless. The service card may have imprinted thereon a telephone number or a web site that may be accessed by the recipient of such card to access the services associated with the card.

When a homeless person uses the service card to obtain services from a provider (an agency, a business, or an individual), the points associated with the service card may be credited to an account associated with such provider in the program database 702. Thereafter, the points credited to the provider may be used thereby to obtain services from another provider.

In some embodiments, an individual or entity may use the points in lieu of money to purchase goods and services provided by another individual or entity.

In some embodiments the point redemption system operates on a server accessible over the Internet, telephone, and/or mobile network. For example, the user (an individual who has points or a representative of an entity who has points) may use a web browser operating on a computer and/or a mobile device to use the point redemption system. Alternately, a telephonic interface may be used to access the point redemption system whereby the user is prompted to enter via pushbuttons of a telephone or speak answers to a series of prompts.

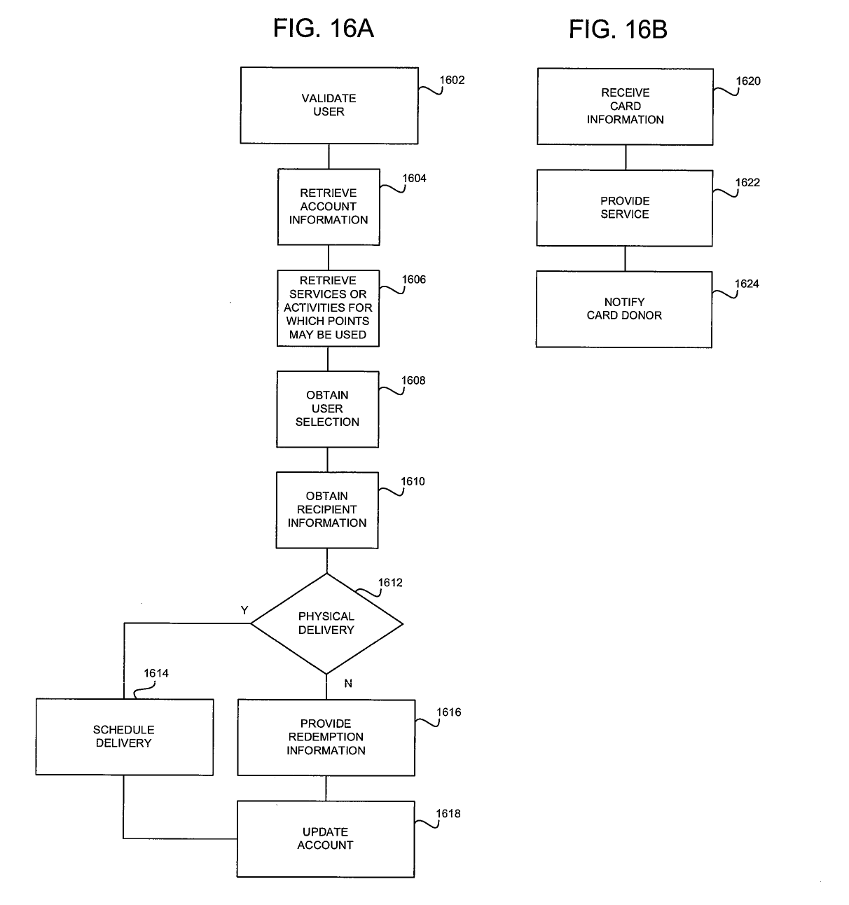

FIG. 16A is a flowchart of program code that may be executed in one embodiment of the system to enable a user to redeem points. A block 1602 requests authentication information from the user. A block 1604 uses authentication information to retrieve account information from a database regarding points accrued by the user or the entity represented thereby. A block 1606 retrieves information regarding the services or activities for which the points may be used. The services or activities may include membership to the social network, access to information provided by skilled individuals, tickets to events, and the like. The activities and services may be specified by the operator of the system and may be modified thereby. A block 1608 obtains a selection of an activity or service from the user and a block 1610 obtains information regarding the recipient of the activity or service. The recipient may be identical to the user or may be another individual or entity.

A block 1612 determines whether the activity or service involves a physical delivery. If a physical delivery is involved, a block 1614 schedules the production (if necessary) and the delivery of a physical item to the recipient. Examples of items that may be physically delivered include the service card as described above, tickets for an event, a confirmation letter or postcard to the user or another individual of a transfer of points, a donated good, and the like. After the block 1614, execution proceeds to a block 1618.

If at the block 1612, the system determines that a physical delivery is not necessary, then execution proceeds to a block 1616. The block 1616 provides redemption and/or confirmation information to the user. The redemption information may be provided as an electronic mail message or as a file (e.g., PDF) that may be printed by the user. For example, if the user purchases a service card, the service card may be provided thereto as a PDF file to be printed. The user may print the file and give the printed output to a recipient of the service card. After block 1616 execution proceeds to a block 1618 where the points redeemed by the user are deducted from the account associated therewith, any other updates are made to the account associated therewith, and the program database 702 is updated accordingly.

In some cases, if an individual provides points, a service card, or the like to a recipient, the individual may wish to be notified when the recipient makes use of the points or service card. FIG. 16B is a flowchart of program code that may be executed by a system upon redemption of points or a service card by a recipient to generate a notification to the individual who provided the points or service card. At a block 1620, the system receives, for example, service card information from the recipient. A block 1622 executes code necessary (for example, the blocks shown in the flowchart of FIG. 12), and a block 1624 notifies the individual who gave the recipient the service card or points that such card/points have been used.

### INDUSTRIAL APPLICABILITY

It should be apparent that the program database 702 and the donation database 104 may be populated from numerous sources and the embodiments described above are examples of a few. Furthermore, such databases may be used to generate contributions of donations in response to the sale of a variety of products and services, including those products, for example, the pig shaped container, which may be re-used to accumulate further donations. In addition to generating donations for worthwhile causes, the embodiments described herein may be useful for revitalizing communities or identifying services and products that improve the quality of life of the citizens of such communities.

Numerous modifications to the system(s) and processes(s) described herein will be apparent to those skilled in the art in view of the foregoing description. Accordingly, this description is to be construed as illustrative only.

We claim:

1. A computer program product for processing a donation from a donor to a recipient, the computer program product embodied on a computer-readable medium and comprising code that, when executed, causes the computer to perform the following:
receive data associated with a transaction undertaken by the donor;
identify a charity to receive a donation in accordance with the data;
determine an escrow amount associated with the recipient;
calculate a donation amount in accordance with the data and the escrow amount; and
transfer a donation equal to the donation amount to the recipient.

2. The computer program product of claim 1, wherein causing the computer to receive data comprises causing the computer to receive data associated with the purchase of a product.

3. The computer program product of claim 1, wherein causing the computer to receive data comprises causing the computer to receive data associated with the return of a product.

4. The computer program product of claim 3, wherein the computer program product further causes the computer to determine the value of a donation previously made when the returned product was purchased and still further causes the computer to adjust the escrow amount associated with the recipient in accordance with the value of the donation previously made.

5. The computer program product of claim 1, wherein the transaction is undertaken at a kiosk.

6. The computer program product of claim 1, wherein the transaction is undertaken over a network.

7. The computer program product of claim 1, wherein the computer program product further causes the computer to determine a value of a donation previously escrowed and to transfer a further donation amount equal to the value of the donation previously escrowed.

8. The computer program product of claim 1, wherein causing the computer to determine a donation amount comprises causing the computer to determine a profit margin associated with the transaction.

9. The computer program product of claim 1, wherein causing the computer to determine a donation amount comprises causing the computer to determine a revenue amount associated with the transaction.

10. The computer program product of claim 1, wherein the computer program product further causes the computer to update a scoreboard in accordance with the donation.

11. A method of operating an electronic display, wherein the method comprises the steps of:
receiving information regarding a donation;
associating a region of the electronic display with the donation, wherein the area occupied by the region is associated with the value of the donation;
generating an image associated with the region to be displayed, wherein the image includes at least a portion of the information.

12. The method of claim 11, wherein the method comprises the further step of generating an image associated with the electronic display from images associated with a plurality of regions.

13. The method of claim 11, wherein the electronic display is an electronic billboard.

14. The method of claim 11, wherein the electronic display is a computer terminal.

15. The method of claim 11, wherein the method comprises the further step of displaying a tally that represents an aggregate of values of the donations associated the regions of the electronic display.

16. The method of claim 11, wherein the step of displaying a tally comprises the step of calculating the weight of a currency having a value equal to the aggregate of values of donations.

17. The method of claim 11, wherein the method comprises the step of selecting the region and displaying additional information regarding the donation associated with the selected region.

18. A computer program product for managing an exchange of a service or donation between a first entity or individual and a second entity or individual, the computer program product embodied on a computer-readable medium and comprising code that, when executed, causes the computer to perform the following:
operate a database that tracks first points and second points associated with the first entity or individual and the second entity or individual, respectively;
track information regarding a service or donation provided by the first entity or individual to the second entity or individual;
develop a value in points for the service or donation provided by the first entity or individual;
generate a first new value of the first points that is a result of adding to the value of the first points associated with the first entity or individual an amount equal to the developed value;
generate a second new value of the second points that is a result of deducting from the value of second points associated with the second entity or individual an amount equal to the developed value; and
store the first new value and the second new value in the database.

19. The computer program product of claim 18, wherein if a service is exchanged, the computer program product causes the computer to determine the value in points of the service in accordance with the skill of a person providing the service and the effort expended to provide the service.

20. The computer program product of claim 18, wherein if a donation is exchanged, the computer program product causes the computer to determine the value in points of the donation in accordance with a current monetary value of the donation.
